(19) United States
(12) Patent Application Publication
(10) Pub. No.: US 2025/0110861 A1
(43) Pub. Date: Apr. 3, 2025

(54) Data Compression Using Reconfigurable Hardware based on Data Redundancy Patterns

(71) Applicant: Advanced Micro Devices, Inc., Santa Clara, CA (US)

(72) Inventors: Moumita Dey, San Jose, CA (US); Varun Agrawal, Westford, MA (US)

(73) Assignee: Advanced Micro Devices, Inc., Santa Clara, CA (US)

(21) Appl. No.: 18/374,815

(22) Filed: Sep. 29, 2023

(51) Int. Cl. G06F 12/02

(52) U.S. Cl. CPC G06F 12/023; G06F 2212/401

(57) ABSTRACT

In accordance with the described techniques for data compression using reconfigurable hardware based on data redundancy patterns, a computing device includes a memory, processing-in-memory units, a host processing unit, and a compression unit having reconfigurable logic for performing multiple compression algorithms. The host processing unit issues processing-in-memory requests instructing the processing-in-memory units to scan a block of the memory for one or more data redundancy patterns, and to identify a compression algorithm of the multiple compression algorithms based on the one or more data redundancy patterns. Further, the host processing unit issues a memory request to access a memory address in the block of the memory. The memory request causes data of the memory address to be communicated from the block of the memory to the compression unit to be compressed using the compression algorithm.

### BACKGROUND

Data compression is the process of transforming an original representation of data to a compressed representation of the data, such that the compressed representation is smaller (e.g., represented by fewer bits) than the original representation. More specifically, hardware data compression involves the use of specialized compression hardware to compress and decompress data being transferred between memory and a host processor. Due to its reduced size, more compressed data is transferrable between hardware components of a system in fewer memory transactions, in comparison to uncompressed data. In addition, compressed data consumes fewer memory resources, and is transferrable between the hardware components of the system relatively faster than uncompressed data. Accordingly, systems that implement data compression benefit from increased effective memory bandwidth, reduced data transfer energy, reduced data transfer latency, and conservation of memory resources. Moreover, systems that implement hardware data compression techniques compress data relatively faster than software data compression techniques, and do so while reducing computational overhead on the host processor.

### BRIEF DESCRIPTION OF THE DRAWINGS

FIG. 1 is a block diagram of a non-limiting example system to implement techniques for data compression using reconfigurable hardware based on data redundancy patterns.

FIG. 2 depicts a non-limiting example for data compression in accordance with the described techniques.

FIG. 3 depicts a non-limiting example for data decompression in accordance with the described techniques.

FIG. 4 depicts a procedure in an example implementation of data compression using reconfigurable hardware based on data redundancy patterns.

### DETAILED DESCRIPTION

### Overview

A system includes a compression unit, a host processing unit, a memory controller, and a memory module having a memory and one or more processing-in-memory units. In accordance with the described techniques, the compression unit is configured to perform operations for data compression and/or data decompression on and/or using data in the memory. However, conventional techniques for hardware-based data compression and decompression rely on compression units that are burned into the silicon of a computer chip on which the compression units are integrated. Given this, conventionally-configured compression units are not reprogrammable or reconfigurable to perform different compression algorithms.

Notably, different workloads have different data redundancies, and different compression algorithms achieve optimal compression ratios for these different data redundancies. By way of example, redundancy-based compression algorithms that target data having a certain type of redundancy (e.g., zero values, delta values, frequent values, etc.) achieve higher compression ratios for workloads that rely on data having the certain type of redundancy. In contrast, dictionary-based compression algorithms have increased applicability across a variety of workloads having different data redundancies, and as such, achieve higher overall compression ratios for systems that process different types of workloads.

Due to the increased applicability and the inability to perform multiple compression algorithms on a conventionally-configured compression unit, conventional systems often opt to implement dictionary-based compression algorithms. This is true despite the dictionary-based compression algorithms achieving sub-optimal compression ratios for workloads that exhibit just one (or a few) of the above-mentioned data redundancies.

To solve these problems, the described techniques implement the compression unit as a reconfigurable hardware device (e.g., a field-programmable gate array) having hardware elements that are reconfigurable at runtime to perform a plurality of different compression algorithms. In accordance with the described techniques, the host processing unit issues processing-in-memory requests instructing the processing-in-memory units to scan a block of the memory for one or more data redundancy patterns. The host processing unit identifies the block of the memory based on an upcoming workload or an upcoming phase of a workload (e.g., a workload or workload phase that is about to be executed) accessing the block of the memory. As part of scanning the block of the memory, the processing-in-memory units determine whether the data in the block is compressible. If so, the processing-in-memory units identify a suitable compression algorithm based on the one or more data redundancy patterns. By way of example, if the scanned block of the memory exhibits zero value data redundancies, the processing-in-memory units identify a zero value data compression algorithm. Upon identifying the appropriate compression algorithm based on the data redundancy patterns, the processing-in-memory units populate a compressibility check region of the memory with metadata indicating that the block of the memory is compressible and the compression algorithm suitable for the block of the memory.

After the compressibility check region is populated with the metadata, the memory controller receives a memory request to access a memory address in the block of the memory. In response, the memory controller reads the data of the memory address from the block of the memory and reads the metadata from the compressibility check region. Upon determining that the data is compressible based on the metadata, the memory controller communicates a compression request to the compression unit. The compression unit instructs the compression unit to compress the data using the compression algorithm identified based on the data redundancy patterns of the block of the memory.

Therefore, the described techniques enable selection and implementation of multiple different compression algorithms based on data redundancy patterns exhibited by the data being compressed. Accordingly, the described techniques implement the compression algorithm that achieves a highest compression ratio from among the multiple compression algorithms performable by the compression unit, thereby achieving higher overall compression ratios as compared to conventionally-configured compression units that solely perform one compression algorithm. Due to the higher compression ratios, the described techniques improve computer performance over conventional techniques by increasing effective memory bandwidth, reducing data transfer energy, and conserving memory resources. Moreover, by scanning the block of the memory for data redundancies using the processing-in-memory units, the data being processed is not communicated back and forth between the memory module and the host processing unit. This further improves computer performance by further reducing memory bandwidth consumption, reducing data transfer energy, and conserving computational resources on the host processing unit.

In some aspects, the techniques described herein relate to a computing device, comprising a compression unit having reconfigurable logic for performing multiple compression algorithms, a memory, processing-in-memory units, and a host processing unit, to issue processing-in-memory requests instructing the processing-in-memory units to scan a block of the memory for one or more data redundancy patterns, and identify a compression algorithm of the multiple compression algorithms based on the one or more data redundancy patterns, and issue a memory request to access a memory address in the block of the memory, the memory request causing data of the memory address to be communicated from the block of the memory to the compression unit to be compressed using the compression algorithm.

In some aspects, the techniques described herein relate to a computing device, wherein the processing-in-memory requests further instruct the processing-in-memory units to store, in a compressibility check region of the memory, metadata indicating the compression algorithm and a compressibility of the data in the block of the memory.

In some aspects, the techniques described herein relate to a computing device, wherein the computing device further includes a memory controller, and the memory request causes the memory controller to read the data of the memory address from the block of the memory, read the metadata from the compressibility check region, and issue, based on the compressibility indicating that the data is compressible, a compression request including the data and the metadata to the compression unit, the compression request instructing the compression unit to compress the data using the compression algorithm.

In some aspects, the techniques described herein relate to a computing device, wherein the host processing unit is configured to issue the processing-in-memory requests based on a workload or a phase of the workload accessing the block of the memory.

In some aspects, the techniques described herein relate to a computing device, wherein the host processing unit is configured to issue the processing-in-memory requests preemptively before the host processing unit begins executing the workload or the phase of the workload based on one or more memory access patterns associated with the workload.

In some aspects, the techniques described herein relate to a computing device, wherein to identify the compression algorithm, the processing-in-memory units are configured to scan a sub-region of the block of the memory for the one or more data redundancy patterns, and identify the compression algorithm that is applicable to the block of the memory based on the one or more data redundancy patterns of the sub-region.

In some aspects, the techniques described herein relate to a computing device, wherein to identify the compression algorithm, the processing-in-memory units are configured to scan a subset of memory rows in the block of the memory for the one or more data redundancy patterns, and identify the compression algorithm that is applicable to the block of the memory based on the one or more data redundancy patterns of the subset of memory rows.

In some aspects, the techniques described herein relate to a computing device, wherein to scan the block of the memory for the one or more data redundancy patterns, the processing-in-memory units are configured to scan at least a portion of a memory row in the block of the memory for the one or more data redundancy patterns across multiple banks of the memory in parallel.

In some aspects, the techniques described herein relate to a computing device, wherein the host processing unit is further configured to receive, from the compression unit, compressed data including the data as compressed using the compression algorithm, and store, in a cache of the host processing unit, the compressed data and metadata indicating the compression algorithm.

In some aspects, the techniques described herein relate to a computing device, wherein the host processing unit is configured to receive an additional memory request to access the memory address, and communicate, based on the memory address hitting in the cache, the compressed data to the compression unit, thereby causing the compression unit to generate decompressed data by decompressing the compressed data using the compression algorithm indicated by the metadata.

In some aspects, the techniques described herein relate to a computing device, wherein the host processing unit is configured to receive, from the compression unit, the decompressed data, and store, in an additional cache of the host processing unit, the decompressed data.

In some aspects, the techniques described herein relate to an apparatus, comprising a compression unit having reconfigurable logic for performing multiple compression algorithms, a memory, and a host processing unit, to store, in a cache of the host processing unit, compressed data associated with a memory address and metadata indicating a compression algorithm of the multiple compression algorithms used to compress the compressed data, the compression algorithm identified based on one or more data redundancy patterns associated with a block of the memory including the memory address, receive a memory request to access the memory address, and communicate, based on the memory address hitting in the cache, the compressed data to the compression unit, thereby causing the compression unit to generate decompressed data by decompressing the compressed data using the compression algorithm indicated by the metadata.

In some aspects, the techniques described herein relate to an apparatus, wherein the host processing unit is further configured to receive, from the compression unit, the decompressed data, and store, in an additional cache of the host processing unit, the decompressed data.

In some aspects, the techniques described herein relate to an apparatus, wherein the metadata indicates whether data associated with the memory address is stored in a compressed format in the cache, the compression algorithm, and a size of the compressed data.

In some aspects, the techniques described herein relate to an apparatus, wherein to communicate the compressed data, the host processing unit is configured to identify the compressed data within a cache line of the cache based on the size of the compressed data.

In some aspects, the techniques described herein relate to an apparatus, wherein the host processing unit is configured to communicate the compressed data to the compression unit for decompression based on the metadata indicating that the data associated with the memory address is stored in the compressed format in the cache.

In some aspects, the techniques described herein relate to an apparatus, wherein the apparatus further includes processing-in-memory units, and the host processing unit is configured to issue processing-in-memory requests instructing the processing-in-memory units to scan the block of the memory for the one or more data redundancy patterns, and identify the compression algorithm based on the one or more data redundancy patterns.

In some aspects, the techniques described herein relate to a method, comprising receiving, by a memory controller, a memory request to access a memory address, retrieving, by the memory controller, data and metadata associated with the memory address from memory, the metadata indicating a compression algorithm by which the data is to be compressed, the compression algorithm identified based on one or more data redundancy patterns of a block of the memory including the memory address, and issuing, by the memory controller, a compression request to a compression unit having reconfigurable logic for performing multiple compression algorithms, the compression request instructing the compression unit to compress the data using the compression algorithm indicated by the metadata.

In some aspects, the techniques described herein relate to a method, further comprising issuing, by the memory controller, processing-in-memory commands instructing processing-in-memory units to scan the block of the memory for the one or more data redundancy patterns, identify the compression algorithm from the multiple compression algorithms based on the one or more data redundancy patterns, and store the metadata in a compressibility check region of the memory, the metadata indicating that the data is compressible and the compression algorithm.

In some aspects, the techniques described herein relate to a method, wherein issuing the compression request includes reading, by the memory controller, the data associated with the memory address from the block of the memory, reading, by the memory controller, the metadata from the compressibility check region, and issuing, by the memory controller, the compression request based on the metadata indicating that the data is compressible.

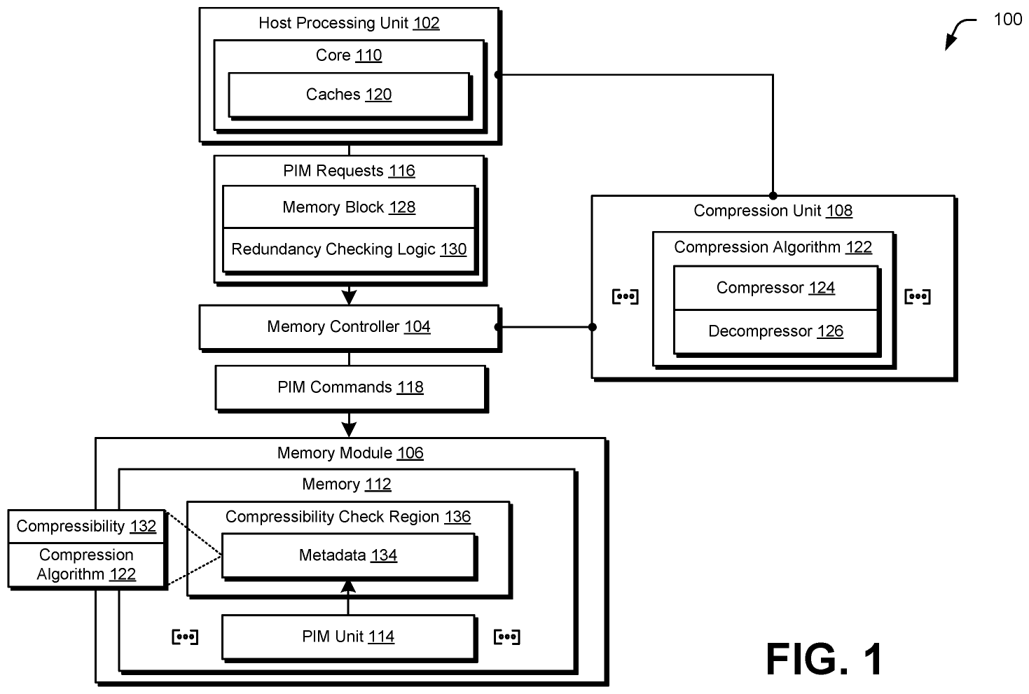

FIG. 1 is a block diagram of a non-limiting example system 100 to implement techniques for data compression using reconfigurable hardware based on data redundancy patterns. In particular, the system 100 includes a host processing unit 102, a memory controller 104, a memory module 106, and a compression unit 108. Further, the host processing unit 102 includes at least one core 110, and the memory module 106 includes a memory 112 and one or more processing-in-memory (PIM) units 114.

In accordance with the described techniques, the various hardware components are coupled to one another via one or more wired or wireless connections. Indeed, the host processing unit 102 is communicatively coupled to the memory controller 104 via the one or more wired or wireless connections, the memory controller 104 is communicatively coupled to the memory module 106 via the one or more wired or wireless connections, and the compression unit 108 is communicatively coupled to both the host processing unit 102 and the memory controller 104 via the one or more wired or wireless connections. Example wired connections include, but are not limited to, buses (e.g., a data bus), interconnects, traces, and planes. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The host processing unit 102 is an electronic circuit that performs various operations on and/or using data in the memory 112. Examples of the host processing unit 102 and/or the core 110 include, but are not limited to, a central processing unit (CPU), a graphics processing unit (GPU), a field programmable gate array (FPGA), an accelerated processing unit (APU), and a digital signal processor (DSP). For example, the core 110 is a processing unit that reads and executes commands (e.g., of a program), examples of which include to add data, to move data, and to branch. Although one core 110 is depicted in the example system 100, the host processing unit 102 includes more than one core 110 in variations, e.g., the host processing unit 102 is a multi-core processor.

In one or more implementations, the memory module 106 is a circuit board (e.g., a printed circuit board), on which the memory 112 is mounted and includes the PIM unit 114. In some variations, one or more integrated circuits of the memory 112 are mounted on the circuit board of the memory module 106, and the memory module 106 includes one or more PIM units 114. Examples of the memory module 106 include, but are not limited to, a TransFlash memory module, a single in-line memory module (SIMM), and a dual in-line memory module (DIMM). In one or more implementations, the memory module 106 is a single integrated circuit device that incorporates the memory 112 and one or more PIM units 114 on a single chip. In some examples, the memory module 106 is composed of multiple chips that implement the memory 112 and the one or more PIM units 114, and the multiple chips are vertically (“3D”) stacked together, are placed side-by-side on an interposer or substrate, or are assembled via a combination of vertical stacking or side-by-side placement.

The memory 112 is a device or system that is used to store information, such as for immediate use in a device, e.g., by the core 110 of the host processing unit 102 and/or by the PIM unit 114. In one or more implementations, the memory 112 corresponds to semiconductor memory where data is stored within memory cells on one or more integrated circuits. In at least one example, the memory 112 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 112 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Thus, the memory 112 is configurable in a variety of ways that support data compression using reconfigurable hardware based on data redundancy patterns without departing from the spirit or scope of the described techniques.

The memory controller 104 is a digital circuit that manages the flow of data to and from the memory 112. By way of example, the memory controller 104 includes logic to read and write to the memory 112. In one or more implementations, the memory controller 104 also includes logic to interface with PIM unit 114, e.g., to provide commands to the PIM unit 114 for processing by the PIM unit 114. The memory controller 104 also interfaces with the core 110. For instance, the memory controller 104 receives commands from the core 110 which involve accessing the memory 112 and/or the PIM unit 114 and provides data to the core 110, e.g., for processing by the core 110. In one or more implementations, the memory controller 104 is communicatively and/or topologically located between the core 110 and the memory module 106, and the memory controller 104 interfaces with the core 110 and the memory module 106.

Broadly, the PIM unit 114 corresponds to or includes one or more in-memory processors, e.g., embedded within the memory module 106. The in-memory processors are implemented with example processing capabilities ranging from relatively simple (e.g., an adding machine) to relatively complex (e.g., a CPU/GPU compute core). The host processing unit 102 is configured to offload memory bound computations to the one or more in-memory processors of the PIM unit 114. To do so, the core 110 generates PIM requests 116 and transmits the PIM requests 116 to the memory controller 104. Further, the memory controller 104 converts the PIM requests 116 to PIM commands 118 (which are executable by the PIM unit 114), and transmits the PIM commands 118 to the PIM unit 114. The PIM unit 114 receives the PIM commands 118 and processes the PIM commands 118 using the one or more in-memory processors and utilizing data stored in the memory 112.

Processing-in-memory using in-memory processors contrasts with standard computer architectures which obtain data from memory 112, communicate the data to the core 110 of the host processing unit 102, and process the data using the core 110 rather than the PIM unit 114. In various scenarios, the data produced by the core 110 as a result of processing the obtained data is written back to the memory 112, which involves communicating the produced data over the pathway from the core 110 to the memory 112. In terms of data communication pathways, the core 110 is further away from the memory 112 than the PIM unit 114. As a result, these standard computer architectures suffer from increased data transfer latency, reduced data communication bandwidth, and increased data communication energy, particularly when the volume of data transferred between the memory 112 and the host processing unit 102 is large, which also decreases overall computer performance.

Thus, the PIM unit 114 enables increased computer performance while reducing data transfer energy and increasing memory bandwidth as compared to standard computer architectures which use the core 110 of the host processing unit 102 to process data. Further, the PIM unit 114 alleviates memory performance and energy bottlenecks by moving one or more memory-intensive computations closer to the memory 112. Although the PIM unit 114 is illustrated as being disposed within the memory module 106, it is to be appreciated that in some examples, the described benefits of data compression using reconfigurable hardware based on data redundancy patterns are realizable through near-memory processing implementations in which the PIM component unit 114 is disposed in closer proximity to the memory 112 (e.g., in terms of data communication pathways and/or topology) than the core 110 of the host processing unit 102.

In one or more implementations, the host processing unit 102 stores data in one or more caches 120 of the core 110. By way of example, the host processing unit 102 is a multi-core processor, and each respective core 110 has a level 1 cache and a level 2 cache that are native to the respective core 110. Further, the host processing unit 102 includes a level 3 cache that is shared among all cores 110 of the multi-core processor. In terms of data communication pathways, the caches 120 are closer to the core 110 than the memory 112, and as such, data stored in the caches 120 is accessible faster by the core 110 than data stored in the memory 112. Broadly, data stored in higher-level caches (e.g., the level 1 cache) is accessible relatively faster than data stored in lower-level caches (e.g., the level 3 cache), but the lower-level caches have increased memory capacity than the higher-level caches. It is to be appreciated that the one or more cores 110 of the host processing unit 102 can include cache subsystems with differing numbers of caches and different hierarchical structures without departing from the spirit or scope of the described techniques.

Data compression is the process of transforming an original representation of data to a compressed representation of the data, such that the compressed representation is smaller (e.g., represented by fewer bits) than the original representation. Data compression enables performance benefits including increased effective memory bandwidth, reduced data transfer energy, reduced data transfer latency, and conservation of memory resources. Indeed, due to its reduced size, compressed data is transferrable between the hardware components of the system 100 (e.g., the host processing unit 102, the memory controller 104, and the memory module 106) in fewer memory transactions, in comparison to compressed data. In addition, compressed data consumes fewer memory resources (e.g., takes up less space in the caches 120), and is transferrable between the hardware components of the system 100 relatively faster than uncompressed data. These performance benefits are further enhanced in correlation with a degree to which data is compressed, e.g., in correlation with an achieved compression ratio. Generally, computing systems implement a compression algorithm to compress data.

Notably, different applications, different workloads of applications, and different phases of workloads have different data redundancies, and different compression algorithms achieve optimal compression ratios for these different data redundancies. By way of example, redundancy-based compression algorithms that target data having a certain type of redundancy (e.g., zero values, delta values, frequent values, etc.) achieve higher compression ratios for applications, application workloads, and/or workload phases that rely on data having the certain type of redundancy. However, these compression algorithms achieve lower overall compression ratios. This is because redundancy-based compression algorithms have decreased applicability across different applications, workloads, and/or phases that rely on data having different types of data redundancies. In contrast, more complex dictionary-based compression algorithms have increased applicability to different applications, workloads, and phases, and as such, dictionary-based compression algorithms achieve higher overall compression ratios.

Conventional techniques for hardware-implemented data compression and decompression rely on compression units having fixed logic for performing solely one compression algorithm. Indeed, conventional compression units are burned into the silicon of a computer chip on which the conventional compression units are integrated. Given this, conventional compression units are not reprogrammable or reconfigurable to perform different compression algorithms. As a result, conventional systems often implement dictionary-based compression algorithms on compression units due to improved overall compression ratios across different applications, workloads, and phases, as compared to redundancy-based compression algorithms. However, these dictionary-based compression units achieve sub-optimal compression ratios for those applications, workloads, and phases that exhibit just one (or a few) of the redundancies targeted by the redundancy-based compression algorithms.

To solve these problems, the system 100 includes the compression unit 108 having reconfigurable logic for performing a plurality of different compression algorithms 122. Indeed, the compression unit 108 is an electronic circuit that performs various operations for data compression and data decompression on and/or using data in the memory 112. In particular, the compression unit 108 is a reconfigurable hardware device having hardware elements (e.g., logic blocks, logic gates, execution units) that are reconfigurable at runtime to implement a plurality of different compression algorithms 122. In at least one example, the compression unit 108 is a field-programmable gate array (FGPA). As shown, each compression algorithm 122 that is executable by the compression unit 108 includes a compressor 124, and a decompressor 126. The compressor 124 is representative of a set of hardware elements configured for compressing data in accordance with the compression algorithm 122, while the decompressor 126 is representative of a set of hardware elements configured for decompressing compressed data in accordance with the compression algorithm 122.

At any given point in time, the compression unit 108 includes the hardware implementations of multiple different compression algorithms 122, e.g., the compression unit 108 is configured in a manner that supports compression and decompression using multiple different compression algorithms 122. In addition, the compression unit 108 is updatable at runtime to include additional compression algorithms 122, modify existing compression algorithms 122, and/or replace existing compression algorithms 122 with new compression algorithms 122.

In an example, the host processing unit 102 is executing an application or a workload that is suitable for a compression algorithm 122 that is not yet implemented on the reconfigurable hardware of the compression unit 108. In this example, unused hardware elements of the compression unit 108 are configured (or hardware elements assigned to a different compression algorithm 122 are reconfigured) to include a compressor 124 and a decompressor 126 of the new compression algorithm 122. In another example, the compression unit 108 implements dictionaries associated with dictionary-based compression algorithms within the reconfigurable hardware. In this example, the compression unit 108 is reconfigurable to update the dictionaries, e.g., to include additional dictionary entries and/or remove existing dictionary entries. Thus, the compression unit 108 enables data compression and data decompression using a multitude of compression algorithms 122 while reducing hardware footprint since a subset of the implementable compression algorithms 122 are integrated into the reconfigurable hardware of the compression unit 108 at a given point in time.

In accordance with the described techniques, the host processing unit 102 issues PIM requests 116 to the memory controller 104. As shown, the PIM requests 116 identify a memory block 128 and embody redundancy checking logic 130. Broadly, the memory block 128 is a portion of the memory 112. Further, the redundancy checking logic 130 includes operations for scanning the memory block 128 for data redundancy patterns, and identifying a corresponding compression algorithm 122 based on the data redundancy patterns. In one or more implementations, system software (e.g., an operating system and/or an application) runs on the core 110 alongside various workloads of an application, and the system software is pre-compiled with the PIM requests 116 including the redundancy checking logic 130. In one or more examples, the PIM requests 116 embodying the redundancy checking logic 130 correspond to PIM instructions that are supported by an instruction set architecture (ISA) utilized by the system software.

The host processing unit 102 is configured to issue the PIM requests 116 periodically based on workloads and/or workload phases accessing different portions of the memory 112. By way of example, the host processing unit 102 issues the PIM requests 116 targeting the memory block 128 based on a new workload being processed, and the new workload accessing data in the memory block 128. Additionally or alternatively, the host processing unit 102 issues the PIM requests 116 targeting the memory block 128 based on a new phase of a workload being processed, and the new phase accessing data in the memory block 128.

In one or more implementations, the host processing unit 102 issues the PIM requests 116 preemptively for a workload or a workload phase before the host processing unit 102 begins executing the workload or the workload phase based on memory access patterns of previously-executed workloads and/or previously-executed workload phases. In machine learning workloads, for example, different layers of a machine learning model operate on different sets of data. In these workloads, the system software is aware of which portions of the memory 112 to which the different sets of data are mapped. Given this, the host processing unit 102 issues the PIM requests 116 targeting the memory block 128 (e.g., the set of data) associated with a subsequent layer of the machine learning model (e.g., a subsequent workload or a subsequent phase of the workload), while the host processing unit 102 is actively issuing commands associated with a previous layer of the machine learning model, e.g., a previously-executed workload or a previously-executed phase of the workload.

As shown, the PIM requests 116 are received by the memory controller 104, which converts the PIM requests 116 to PIM commands 118 (e.g., PIM-Load commands and PIM-Operate commands) that are executable by the PIM unit 114 to implement the redundancy checking logic 130. To execute the PIM commands 118, the PIM units 114 scan the memory block 128 (or a portion of the memory block 128) for one or more data redundancy patterns. As part of this, the PIM units 114 determine compressibility 132 of the data in the memory block 128, which indicates whether the data is compressible. If the data is determined to be compressible, the PIM units 114 further identify a compression algorithm 122 based on the one or more data redundancy patterns.

In an example in which the memory block 128 exhibits a zero value data redundancy, the PIM units 114 identify a zero value compression algorithm (ZCA), e.g., Zero-Content Augmented Caches. In another example in which the memory block 128 exhibits a delta value data redundancy, the PIM units 114 identify a delta value compression algorithm, e.g., Base-Delta-Immediate (BDI) Compression. In yet another example in which the memory block 128 exhibits a frequent value data redundancy, the PIM units 114 identify a frequent value compression (FVC) algorithm. In yet another example in which the memory block 128 exhibits a frequent pattern data redundancy, the PIM units 114 identify a frequent pattern compression (FPC) algorithm. In yet another example in which the PIM units 114 do not identify a data redundancy pattern or identify multiple data redundancy patterns, the PIM units identify a dictionary-based compression algorithm, e.g., Byte-Select Compression (BSC).

By performing the memory scanning operations using the PIM units 114, the data being checked for redundancies is not communicated back and forth between the memory module 106 and the host processing unit 102. This improves computer performance as a result of reduced effective memory bandwidth consumption, reduced data transfer energy, and conservation of computational resources on the host processing unit 102.

In one or more implementations, the PIM commands 118 instruct the PIM units 114 to scan just a portion of the memory block 128 for data redundancy patterns. For instance, the PIM commands 118 instruct the PIM units 114 to solely scan a memory sub-region in the memory block 128 that is relatively smaller than the memory block 128 and representative of the entire memory block 128. Broadly, the memory sub-region of the memory block 128 identifies fewer than all of the memory rows in the memory block 128 and/or less than the entirety of the memory rows identified. Additionally or alternatively, the PIM commands 118 instruct the PIM units 114 to solely scan a subset of one or more memory rows in the memory block 128 that are representative of the entire memory block 128. Additionally or alternatively, the PIM commands 114 instruct the PIM units 114 to solely scan a subset of one or more memory rows within a memory sub-region of the memory block 128. Given this, the PIM units 114 scan a portion of the memory block 128 (e.g., the memory sub-region, the subset of memory rows, or the subset of memory rows within the memory sub-region) for the data redundancy patterns, and identify the compression algorithm based on the data redundancy patterns exhibited by the portion of the memory block 128. Moreover, the identified compression algorithm 122 is applicable to the data of the entire memory block 128, regardless of whether the data was scanned.

Oftentimes, data is striped through different banks and different memory channels in the memory 112. That is, consecutive segments of interacting data are stored in corresponding memory rows across different banks and different memory channels. In these implementations, the data of the memory block 128 (e.g., the data associated with a workload or a workload phase) is similarly striped through corresponding memory rows across different banks and different memory channels. Moreover, each of the PIM units 114 are configured to operate on one or more banks of the memory 112 in parallel to execute a single PIM command 118. Thus, the memory controller 104 issues a single set of one or more commands for each scanned memory row, and the multiple PIM units 114 perform the scanning operation on corresponding memory rows (or corresponding portions of corresponding memory rows) in different banks in parallel.

For at least the reasons described above, the described techniques reduce the number of PIM commands 118 issued to carry out the redundancy checking logic 130. This reduction is achieved by scanning and analyzing a portion of the memory block 128 for data redundancy patterns, rather than the entire memory block 128. This reduction is further achieved by scanning and analyzing a respective memory row (or a portion of a respective memory row) for redundancies across multiple banks of the memory 112 in parallel via a single set of one or more PIM commands 118. By doing so, the described techniques reduce effective memory bandwidth consumption and improve computer performance.

The PIM commands 118 further instruct the PIM units 114 to store metadata 134 in a compressibility check region 136 of the memory 112. Further, the metadata 134 indicates the compressibility 132 of the data in the memory block 128 and the compression algorithm 122 suitable for the data in the memory block 128 based on the data redundancy patterns. Thus, upon receiving a memory request to access a memory address in the memory block 128, the memory controller 104 checks the metadata 134 associated with the memory block 128 in the compressibility check region 136. If the compressibility 132 indicates that the data is compressible, the memory controller 104 communicates the requested data along with the metadata 134 indicating the compression algorithm 122 to the compression unit 108. If the compression unit 108 is not currently configured for compression using the compression algorithm 122, the hardware elements of the compression unit 108 are first reconfigured for data compression using the compression algorithm 122. Next, the compression unit 108 selects the appropriate compressor 124 of the compression algorithm 122, and compresses the data using the compressor 124.

Thus, the described techniques enable selection and implementation of a compression algorithm 122 to compress data based on one or more data redundancy patterns exhibited by the data. By doing so, the described techniques implement the compression algorithm 122 that achieves a highest compression ratio from among the multiple compression algorithms 122 performable by the compression unit 108. The system 100 therefore achieves higher overall compression ratios as compared to conventional systems having conventionally-configured compression units that solely perform one compression algorithm. By achieving higher compression ratios than conventional techniques, the described techniques further improve computer performance by increasing effective memory bandwidth, reducing data transfer energy, reducing data transfer latency, and conserving memory resources for the system 100.

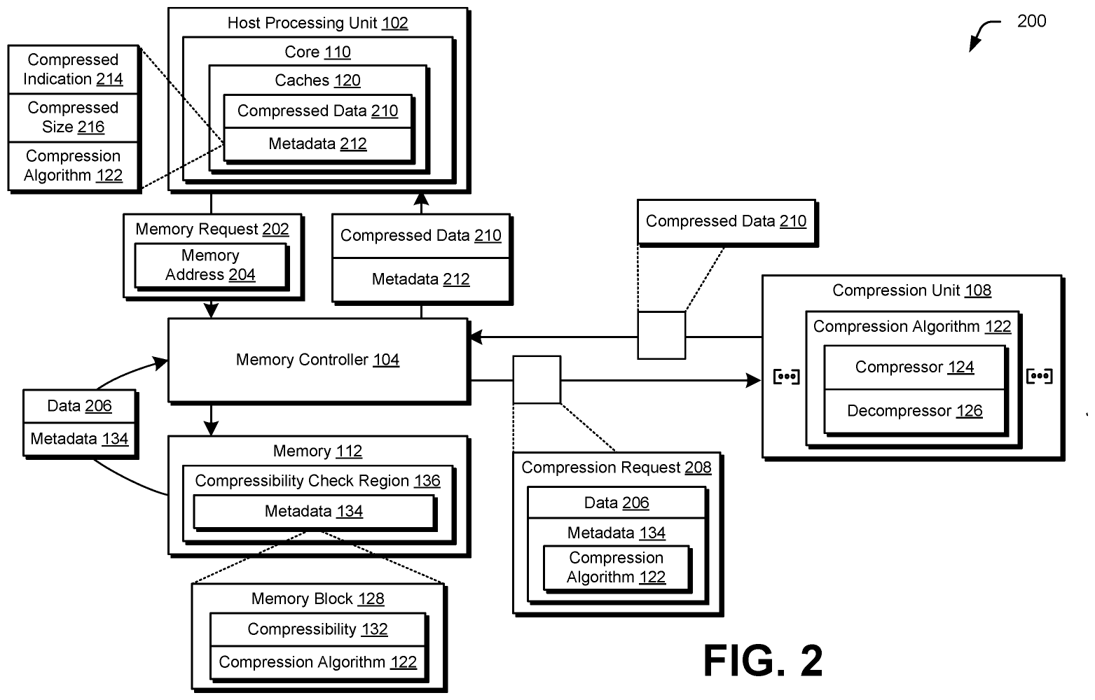

FIG. 2 depicts a non-limiting example 200 for data compression in accordance with the described techniques. As shown, the example 200 includes the host processing unit 102 having the core 110 and the caches 120, the memory controller 104, and the compression unit 108 having the reconfigurable logic for performing a plurality of different compression algorithms 122. In addition, the example 200 includes the memory 112 having the compressibility check region 136 that stores the metadata 134 for the memory block 128. Further, the metadata 134 indicates the compressibility 132 of the memory block 128 and the compression algorithm 122 suitable for the memory block 128 based on the data redundancy patterns.

In accordance with the described techniques, the host processing unit 102 issues a memory request 202 to access a memory address 204 in the memory block 128. By way of example, the memory block 128 stores data associated with a workload or a workload phase, and the host processing unit 102 issues the memory request 202 as part of executing the workload or the workload phase. The memory request 202 is received by the memory controller 104. Based on the memory request 202 accessing the memory address 204 of the memory block 128, the memory controller 104 reads the metadata 134 from the compressibility check region 136. In addition, the memory controller 104 reads data 206 associated with the memory address 204 from the memory block 128.

Furthermore, the memory controller 104 determines whether the data 206 is compressible by analyzing the metadata 134. If the compressibility 132 of the metadata 134 indicates that the data 206 is not compressible, the memory controller 104 transfers the data 206 to the host processing unit 102 for further processing. If, however, the compressibility 132 indicates that the data 206 is compressible, the memory controller 104 issues a compression request 208. Further, the compression request 208 includes the data 206 and the metadata 134 indicating the compression algorithm 122 identified based on the data redundancy patterns of the memory block 128.

As shown, the compression unit 108 receives the compression request 208, which instructs the compression unit 108 to compress the data 206 using the compression algorithm 122 indicated by the metadata 134. Upon receiving the compression request 208, the compression unit 108 analyzes the metadata 134 to determine the compression algorithm 122 by which the data 206 is to be compressed. If the compression unit 108 is not currently configured for compression using the compression algorithm 122, the hardware elements of the compression unit 108 are first reconfigured for data compression using the compression algorithm 122. Next, the compression unit 108 selects the appropriate compressor 124 of the compression algorithm 122, and compresses the data 206 using the compressor 124. In doing so, the compression unit 108 generates compressed data 210, which is communicated back to the memory controller 104.

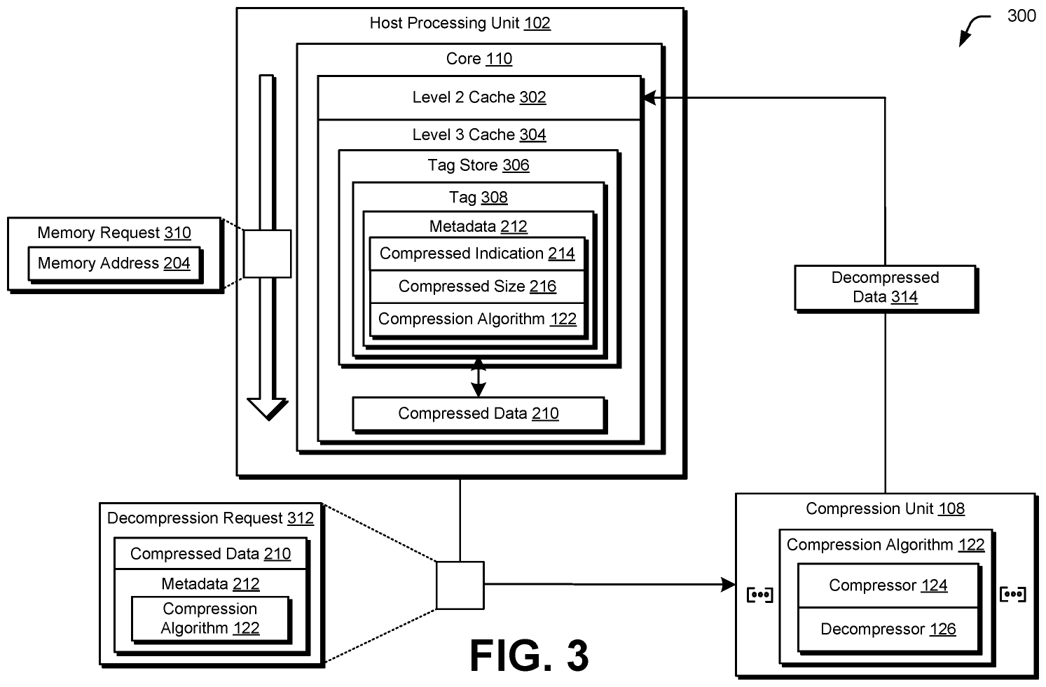

Upon receiving the compressed data 210, the memory controller 104 communicates the compressed data 210 along with metadata 212 for storage in the caches 120 of the host processing unit 102. By way of example, the host processing unit 102 stores the compressed data 210 in a cache line of a lower-level cache (e.g., a level 3 cache), and stores the metadata 212 in a tag store of the lower-level cache. Notably, the tag store is modified to accommodate storage of compression-related metadata. The metadata 212 of the compressed data 210 stored in the caches 120 includes different and/or additional information than the metadata 134 of the memory block 128 stored in the compressibility check region 136. Indeed, the metadata 212 includes a compressed indication 214 which indicates whether data associated with the memory address 204 is stored in a compressed, a compressed size 216 indication which indicates a size (e.g., a number of bytes) of the compressed data 210, and a compression algorithm 122 indication which indicates the compression algorithm 122 by which the compressed data 210 was compressed. As further discussed below with reference to FIG. 3, the metadata 212 is leveraged when the compressed data 210 is subsequently requested and decompressed.

In one or more implementations, multiple lines of compressed data 210 are stored in a single cache line of the lower-level cache. In an example, the lower-level cache includes cache lines that are sixty-four bytes in length, and the compressed data 210 is sixteen bytes in length. Rather than storing the compressed data 210 in its own cache line, the compressed data 210 is stored in a cache line along with one or more other portions of compressed data 210, e.g., three other portions of compressed data 210 that are each sixteen bytes in length. In these implementations, the tag store of the lower-level cache includes additional metadata 212, e.g., to indicate starting and ending bits for the compressed data 210 within the cache line. By implementing cache compression for capacity, the described techniques increase memory resource utilization in the caches 120, which improves overall computer performance. Any one or more of a variety of public or proprietary techniques for cache compression for capacity are employable without departing from the spirit or scope of the described techniques.

FIG. 3 depicts a non-limiting example 300 for data decompression in accordance with the described techniques. As shown, the caches 120 of the host processing unit 102 include a level 2 cache 302 and a level 3 cache 304. Moreover, the level 3 cache 304 includes a tag store 306 which maintains a tag 308 of the memory address 204 which maps to a cache line in the level 3 cache 304 where the compressed data 210 is located. By way of example, the tag 308 is a component of the memory address 204, which is looked up in the caches 120 to determine whether the data associated with the memory address 204 is present in the caches 120 In addition, the tag store 306 includes the metadata 212 associated with the compressed data 210, including the compressed indication 214, the compressed size 216, and the compression algorithm 122 used to compress the compressed data 210.

In accordance with the described techniques, the host processing unit 102 receives a memory request 310 to access the memory address 204, e.g., from an application or operating system executing on the host processing unit 102. To process the memory request 310, the host processing unit 102 checks whether the caches 120 maintain the data associated with the memory address 204. As illustrated by the depicted arrow, the host processing unit 102 propagates the memory request 310 downwards by checking upper-level caches of the multi-level cache hierarchy before lower-level caches of the multi-level cache hierarchy, e.g., the host processing unit 102 first checks the level 1 cache, then the level 2 cache, and then the level 3 cache. Here, the memory address 204 “hits” in the level 3 cache 304 based on the tag 308 in the tag store 306 matching the tag of the memory address 204 of the memory request 310.

In response to the cache hit, the host processing unit 102 reads the metadata 212 from the tag store 306, and obtains the compressed data 210 based on the metadata 212 and the mapping of the tag 308 to the cache line where the compressed data 210 is stored. By way of example, the metadata 212 includes dedicated bits for the compressed indication 214, dedicated bits for the compressed size 216, and dedicated bits for the compression algorithm 122 Based on the cache hit, the host processing unit 102 reads the dedicated bits of the compressed indication 214 to determine whether the data associated with the memory address 204 is stored in a compressed format. If not, the host processing unit 102 obtains the data for further processing (e.g., by the core 110) from the cache line to which the tag 308 is mapped.

Here, however, the compressed indication 214 indicates that the data associated with the memory address 204 is stored in a compressed format. Accordingly, the host processing unit 102 further reads the metadata 212 indicating the compressed size 216 and the compression algorithm 122. Moreover, the host processing unit 102 obtains the compressed data 210 based on the compressed size 216 and the mapping of the tag 308 to the cache line where the compressed data 210 is stored. Consider an example in which the level 3 cache 304 includes cache lines of sixty-four bytes in length and the compressed data 210 is sixteen bytes in length. In this example, the tag 308 indicates the cache line in the level 3 cache 304 where the compressed data 210 is stored, and the compressed size 216 indicates which bits of the cache line the compressed data is stored in. Given this, the host processing unit 102 retrieves the compressed data 210 by reading the first sixteen bytes of the cache line indicated by the mapping. In cache compression for capacity scenarios, the host processing unit 102 retrieves the compressed data 210 from a contiguous sixteen bytes of the cache line indicated by the starting and ending bits for the compressed data 210 within the cache line, e.g., as indicated by the metadata 212.

Upon retrieving the compressed data 210, the host processing unit 102 issues a decompression request 312 including the compressed data 210 and the metadata 212 indicating the compression algorithm 122. Further, the compression unit 108 receives the decompression request 312 and analyzes the metadata 212 to determine the compression algorithm 122 by which the compressed data 210 was compressed. If the compression unit 108 is not currently configured for decompression using the compression algorithm 122, the hardware elements of the compression unit 108 are first reconfigured for data decompression using the compression algorithm 122. Next, the compression unit 108 selects the appropriate decompressor 126 of the compression algorithm 122, and decompresses the compressed data 210 using the decompressor 126. In doing so, the compression unit 108 generates decompressed data 314, which is communicated back to the host processing unit 102 for storage in the level 2 cache 302. In this way, the decompressed data 314 is accessible in the level 2 cache 304 for further processing by the core 110 of the host processing unit 102.

In one or more implementations, the described techniques rely on direct communication between the compression unit 108 and the host processing unit 102, as well as between the compression unit 108 and the memory controller 104. Indeed, during a data compression phase, the compression request 208 and the compressed data 210 are communicated between the compression unit 108 and the memory controller 104. Further, during a data decompression phase, the decompression request 312 and the decompressed data 314 are communicated between the compression unit 108 and the host processing unit 102. Since data compression and data decompression occur simultaneously in various scenarios, the compression unit 108 is simultaneously accessed by both the host processing unit 102 and the memory controller 104 in such scenarios. For these reasons, the compression unit 108 is communicatively coupled to both the host processing unit 102 and the memory controller 104, as illustrated in FIG. 1.

In one or more implementations, the host processing unit 102 and the memory controller 104 are integrated on separate physical chips. For example, a first die includes or corresponds to the host processing unit 102, while a second die is representative of a data fabric that includes the memory controller 104. In a stacked topology scenario in which the first die is stacked on top of the second die, the above-described simultaneous access to the compression unit 108 is facilitated by integrating the compression unit 108 into either the first die or the second die. In a side-by-side topology scenario in which the first die is placed next to the second die, the compression unit 108 is integrated into a third die. Further, the above-described simultaneous access to the compression unit 108 is facilitated by stacking the third die on top of both the first die and the second die.

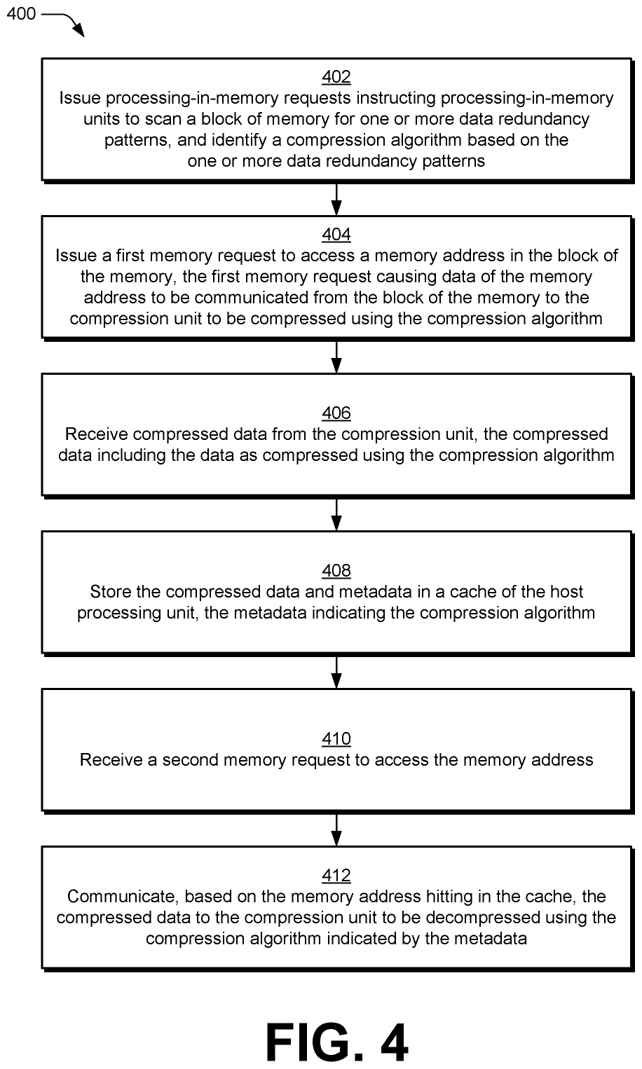

FIG. 4 depicts a procedure 400 in an example implementation of data compression using reconfigurable hardware based on data redundancy patterns. Processing-in-memory requests are issued instructing processing-in-memory units to scan a block of memory for one or more data redundancy patterns, and identify a compression algorithm based on the one or more data redundancy patterns (block 402). By way of example, the host processing unit 102 issues the PIM requests 116 embodying the redundancy checking logic 130, which instruct the PIM units 114 to scan the memory block 128 for data redundancy patterns. The PIM requests 116 further instruct the PIM units 114 to identify a compression algorithm 122 of the multiple compression algorithms performable by the compression unit 108 based on the data redundancy patterns exhibited by the memory block 128. Moreover, the PIM units 114 write metadata 134 to a compressibility check region 136 of the memory 112. The metadata 134 indicates the compressibility 132 of the memory block 128, and the appropriate compression algorithm 122 for compressing the data in the memory block 128.

A first memory request to access a memory address in the block of the memory is issued, and the first memory request causes data of the memory address to be communicated from the block of the memory to the compression unit to be compressed using the compression algorithm (block 404). By way of example, the host processing unit 102 issues the memory request 202 to access the memory address 204 of the memory block 128. Upon receiving the memory request 202, the memory controller 104 reads the data 206 associated with the memory address 204 from the memory block 128. In addition, the memory controller 104 reads the metadata 134 associated with the memory block 128 from the compressibility check region 136. Based on the metadata 134 indicating that the data 206 is compressible, the memory controller 104 issues a compression request 208. The compression request 208 includes the data 206 and metadata 134 indicating the compression algorithm 122, which instructs the compression unit 108 to compress the data 206 using the compressor 124 of the identified compression algorithm 122.

Compressed data is received from the compression unit, and the compressed data includes the data as compressed using the compression algorithm (block 406). By way of example, the compression unit 108 generates compressed data 210 as part of compressing the data 206 using the compressor 124. Further, the compression unit 108 communicates the compressed data 210 to the host processing unit 102 via the memory controller 104.

The compressed data and metadata are stored in a cache of the host processing unit, and the metadata indicates the compression algorithm (block 408). By way of example, the memory controller 104 communicates the metadata 212 along with the compressed data 210 for storage in the caches 120, e.g., in the level 3 cache 304. Indeed, the host processing unit 102 stores the compressed data 210 in a cache line of the level 3 cache 304. Moreover, the host processing unit 102 stores the tag 308 of the memory address 204 in a tag store 306 of the level 3 cache 304, and the tag 308 maps to the cache line where the compressed data 210 is stored. Furthermore, the tag store 306 includes the metadata 212 which includes a compressed indication 214 indicating that the data associated with the memory address 204 is stored in a compressed format, the compressed size 216 indication, and an indication of the compression algorithm 122 by which the compressed data 210 was compressed.

A second memory request to access the memory address is received (block 410). By way of example, the host processing unit 102 receives the memory request 310 to access the memory address 204.

The compressed data is communicated to the compression unit to be decompressed using the compression algorithm indicated by the metadata based on a the memory address hitting in the cache (block 412). By way of example, the host processing unit 102 checks whether the caches 120 store the data associated with the memory address 204. Here, a lookup of the memory address 204 hits in the level 3 cache 304 because the tag store 306 of the level 3 cache 304 includes the tag 308 that matches the memory address 204.

Responsive to the cache hit, the host processing unit 102 reads the metadata 212 associated with the memory address 204 from the tag store 306 to determine that the data associated with the memory address 204 is stored in a compressed format. Further, the host processing unit 102 reads the compressed data 210 from the cache line indicated by the mapping of the tag 308 to the compressed data 210, and from the bits indicated by the compressed size 216. Moreover, the host processing unit 102 issues a decompression request 312 that includes the compressed data 210 and the metadata 212 indicative of the compression algorithm 122. The decompression request 312 instructs the compression unit 108 to decompress the compressed data 210 using the decompressor 126 of the compression algorithm 122. Finally, decompressed data 314 is communicated back to the host processing unit 102 for storage in the level 2 cache 302.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host processing unit 102, the memory controller 104, the memory module 106, the compression unit 108, the core 110, the memory 112, the PIM units 114, and the caches 120) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A computing device, comprising:
a compression unit having reconfigurable logic for performing multiple compression algorithms;
a memory;
processing-in-memory units; and
a host processing unit, to:
issue processing-in-memory requests instructing the processing-in-memory units to scan a block of the memory for one or more data redundancy patterns, and identify a compression algorithm of the multiple compression algorithms based on the one or more data redundancy patterns; and
issue a memory request to access a memory address in the block of the memory, the memory request causing data of the memory address to be communicated from the block of the memory to the compression unit to be compressed using the compression algorithm.

2. The computing device of claim 1, wherein the processing-in-memory requests further instruct the processing-in-memory units to store, in a compressibility check region of the memory, metadata indicating the compression algorithm and a compressibility of the data in the block of the memory.

3. The computing device of claim 2, wherein the computing device further includes a memory controller, and the memory request causes the memory controller to:
read the data of the memory address from the block of the memory;
read the metadata from the compressibility check region; and
issue, based on the compressibility indicating that the data is compressible, a compression request including the data and the metadata to the compression unit, the compression request instructing the compression unit to compress the data using the compression algorithm.

4. The computing device of claim 1, wherein the host processing unit is configured to issue the processing-in-memory requests based on a workload or a phase of the workload accessing the block of the memory.

5. The computing device of claim 4, wherein the host processing unit is configured to issue the processing-in-memory requests preemptively before the host processing unit begins executing the workload or the phase of the workload based on one or more memory access patterns associated with the workload.

6. The computing device of claim 1, wherein to identify the compression algorithm, the processing-in-memory units are configured to scan a sub-region of the block of the memory for the one or more data redundancy patterns, and identify the compression algorithm that is applicable to the block of the memory based on the one or more data redundancy patterns of the sub-region.

7. The computing device of claim 1, wherein to identify the compression algorithm, the processing-in-memory units are configured to scan a subset of memory rows in the block of the memory for the one or more data redundancy patterns, and identify the compression algorithm that is applicable to the block of the memory based on the one or more data redundancy patterns of the subset of memory rows.

8. The computing device of claim 1, wherein to scan the block of the memory for the one or more data redundancy patterns, the processing-in-memory units are configured to scan at least a portion of a memory row in the block of the memory for the one or more data redundancy patterns across multiple banks of the memory in parallel.

9. The computing device of claim 1, wherein the host processing unit is further configured to:
receive, from the compression unit, compressed data including the data as compressed using the compression algorithm; and
store, in a cache of the host processing unit, the compressed data and metadata indicating the compression algorithm.

10. The computing device of claim 9, wherein the host processing unit is configured to:
receive an additional memory request to access the memory address; and
communicate, based on the memory address hitting in the cache, the compressed data to the compression unit, thereby causing the compression unit to generate decompressed data by decompressing the compressed data using the compression algorithm indicated by the metadata.

11. The computing device of claim 10, wherein the host processing unit is configured to:
receive, from the compression unit, the decompressed data; and
store, in an additional cache of the host processing unit, the decompressed data.

12. An apparatus, comprising:
a compression unit having reconfigurable logic for performing multiple compression algorithms;
a memory; and
a host processing unit, to:
store, in a cache of the host processing unit, compressed data associated with a memory address and metadata indicating a compression algorithm of the multiple compression algorithms used to compress the compressed data, the compression algorithm identified based on one or more data redundancy patterns associated with a block of the memory including the memory address;
receive a memory request to access the memory address; and
communicate, based on the memory address hitting in the cache, the compressed data to the compression unit, thereby causing the compression unit to generate decompressed data by decompressing the compressed data using the compression algorithm indicated by the metadata.

13. The apparatus of claim 12, wherein the host processing unit is further configured to:
receive, from the compression unit, the decompressed data; and
store, in an additional cache of the host processing unit, the decompressed data.

14. The apparatus of claim 12, wherein the metadata indicates whether data associated with the memory address is stored in a compressed format in the cache, the compression algorithm, and a size of the compressed data.

15. The apparatus of claim 14, wherein to communicate the compressed data, the host processing unit is configured to identify the compressed data within a cache line of the cache based on the size of the compressed data.

16. The apparatus of claim 14, wherein the host processing unit is configured to communicate the compressed data to the compression unit for decompression based on the metadata indicating that the data associated with the memory address is stored in the compressed format in the cache.

17. The apparatus of claim 12, wherein the apparatus further includes processing-in-memory units, and the host processing unit is configured to issue processing-in-memory requests instructing the processing-in-memory units to scan the block of the memory for the one or more data redundancy patterns, and identify the compression algorithm based on the one or more data redundancy patterns.

18. A method, comprising:
receiving, by a memory controller, a memory request to access a memory address;
retrieving, by the memory controller, data and metadata associated with the memory address from memory, the metadata indicating a compression algorithm by which the data is to be compressed, the compression algorithm identified based on one or more data redundancy patterns of a block of the memory including the memory address; and
issuing, by the memory controller, a compression request to a compression unit having reconfigurable logic for performing multiple compression algorithms, the compression request instructing the compression unit to compress the data using the compression algorithm indicated by the metadata.

19. The method of claim 18, further comprising issuing, by the memory controller, processing-in-memory commands instructing processing-in-memory units to:
scan the block of the memory for the one or more data redundancy patterns;
identify the compression algorithm from the multiple compression algorithms based on the one or more data redundancy patterns; and
store the metadata in a compressibility check region of the memory, the metadata indicating that the data is compressible and the compression algorithm.

20. The method of claim 19, wherein issuing the compression request includes:
reading, by the memory controller, the data associated with the memory address from the block of the memory;
reading, by the memory controller, the metadata from the compressibility check region; and
issuing, by the memory controller, the compression request based on the metadata indicating that the data is compressible.
